(19) United States
(12) Patent Application Publication
(10) Pub. No.: US 2018/0189876 A1
(43) Pub. Date: Jul. 5, 2018

(54) PHOTOGRAPHY PRODUCT CONTRACTING SYSTEM AND METHOD

(71) Applicant: Almaraz L & Co Ltd, Chicago, IL (US)

(72) Inventor: Luis Almaraz, Chicago, IL (US)

(21) Appl. No.: 15/398,899

(22) Filed: Jan. 5, 2017

(51) Int. Cl. G06Q 40/04; G06F 17/30

(52) U.S. Cl. CPC G06Q 40/04; G06F 17/3028

(57) ABSTRACT

A photography product contracting system is provided to facilitate contracting between parties for photography services. The photography product contracting system may include a database, interface, matching component, moment component, commerce component, and content exchange component. Photography products may be exchanged between customers and contractors using the content delivery component locally or relayed by a database. Feedback may be gathered from contractors and customers. A method to facilitate contracting between parties for photography services using the photography product contracting system is also provided.

### FIELD OF THE INVENTION

The present disclosure relates to a photography product contracting system. More particularly, the disclosure relates to facilitating contracting between parties for photography services.

### BACKGROUND

Photographs and other photography products help capture moments for future memories. Photographs and photography products also help share a moment with others that cannot be physically present. Since the advent of digital photography and video, people have been sharing photography products at an increasing rate. However, the ease at which photography products are sharable has grown faster than the ability to acquire high quality photographs.

People desiring to share a photograph, video, or other photography product typically are faced with an undesirable set of options to capture the moment. In a first undesirable option, a member of the group would have to be left out of a photograph, as he or she would be responsible for photographing the others. In a second undesirable option, a person would have to take a “selfie” of their self or group. “Selfies” are known for their informality and lack of professionalism, and can produce unsatisfactory results. In a third option, a member of the group wishing to be photographed may have to approach a stranger to take the picture. In this option, the stranger may produce unsatisfactory photographs due to lack of skill, may decline to take the photograph, or may even attempt to steal the camera or electronic device intended to take the photograph.

Any known prior attempts to address these deficiencies require advance booking of professional photographers for costly photo-shoot sessions, prohibiting their use for spontaneous, casual moments. Additionally, photographs produced through these sessions may not be delivered for days, weeks, or longer. An unfulfilled need exists for on-demand and/or short-notice photography contracting services. An unfulfilled need also exists for quick or nearly instantaneous sharing of digital photography products through a data connection.

The prior art lacks a simple and cost effective way to acquire high quality photographs, using desirable photography equipment and personnel, through contracting of short-term moments. Therefore, a need exists to solve the deficiencies present in the prior art. What is needed is a system to facilitate photography contracting services. What is needed is a system to match photographers with customers for short-term moments. What is needed is a system for organizing photography moments and to facilitate purchase of photographs taken during a moment. What is needed is a system to communicate photographs and digital media among users. What is needed is a system and method to locate contractors for temporary hire by customers. What is needed is a method of locating, contracting, and purchasing from photographers.

### SUMMARY

An aspect of the disclosure advantageously provides a system to facilitate photography contracting services. An aspect of the disclosure advantageously provides a system to match photographers with customers for short-term moments. An aspect of the disclosure advantageously provides a system for organizing photography moments and facilitate purchase of photographs taken during a moment. An aspect of the disclosure advantageously provides a system to communicate photographs and digital media among users. An aspect of the disclosure advantageously provides a system and method to locate contractors for temporary hire by customers. An aspect of the disclosure advantageously provides a method of locating, contracting, and purchasing from photographers.

Accordingly, the disclosure may feature a photography contractor matching system that may include a matching component, a moment component, a commerce component, and a content exchange component. The matching component may assist with connecting a customer and a contractor. The moment component may control a moment between the customer and the contractor, photography products created during the moment being viewable via an interface. The commerce component may collect a fee relating to occurrence of the moment and purchasing at least some of the photography products created during the moment. The content exchange component may facilitate delivering the photography products. A frontend may provide the interface as interactively viewable. The matching component, the moment component, the commerce component, and the content exchange component may be manipulable via the interface. The photography products associated with the moment may be communicable between photography equipment operated by the contractor and the content exchange component. The customer may be associable with a customer profile storable in a database accessible via a network. The contractor may be associable with a contractor profile storable in the database. Some of the photography products may be storable in the database and accessible from the database.

In another aspect, the matching component may include a search module to define criteria for the contractor to be identified and to identify the contractor in compliance with the criteria. The search module may additionally include a mapping module to provide a visualization of the contractor that is identified via the search module using the interface. The contractor profile may include fields analyzable to determine the compliance with the criteria.

In another aspect, a feedback component may be included to receive feedback relating to the contractor, the customer, the moment, and the photography products. At least part of the feedback may be includable in the criteria.

In another aspect, the criteria may include proximity of the contractor to a location of the customer and a category of the contractor.

In another aspect, information regarding a nearby photo opportunity location may be storable in the database and accessible to indicate the nearby photo opportunity location and promote occupancy by the customer and the contractor in the nearby photo opportunity location.

In another aspect, the moment component may include an active moment module to open the moment between the customer and the contractor, manage the moment that is opened, and close the moment that has concluded. The moment component may optionally additionally include a proofing module to review the photography products created during the moment. At least part of the photography products created during the moment may be deliverable to the customer via the content exchange component.

In another aspect, the fee may include a first fee relating to the moment managed by the moment component. The fee may additionally include a second fee relating to purchase of at least some of the photography products created during the moment and deliverable via the content exchange component. The fee may optionally include a commission of the fee collectable by the commerce component and payable to an operator of the system. A first portion of the first fee and a second portion of the second fee may be included in a commission.

In another aspect, the content exchange component may include a local exchange module to deliver at least some of the photography products via an ad-hoc network communication between the frontend associated with the contractor and the frontend associated with the customer.

In another aspect, the content exchange component may include a relayed exchange module to deliver at least some of the photography products via a first relayed communication between the frontend associated with the contractor and the database and a second relayed communication between the database and the frontend associated with the customer.

In another aspect, the moment may be capable of being opened prior to creating the customer profile to be associated with the customer.

In another aspect, the photography products created during the moment may be deliverable after the moment is closed.

According to an embodiment of this disclosure, a photography contractor matching system is provided that may include a matching component, moment component, a content exchange component, and a frontend. The matching component may be used to connect a customer and a contractor. The matching component may include a search module to define criteria for the contractor to be identified and to identify the contractor in compliance with the criteria. The matching component may additionally include a mapping module to provide a visualization of the contractor that is identified via the search module using an interface. The moment component may control a moment between the customer and the contractor, photography products created during the moment being viewable via the interface. The moment component may include an active moment module to open the moment between the customer and the contractor, manage the moment that is opened, and close the moment that has concluded. The moment component may optionally include a proofing module to review the photography products created during the moment. The content exchange component may facilitate delivering the photography products. The frontend may provide the interface as interactively viewable. The matching component, the moment component, and the content exchange component may be manipulable via the frontend. The photography products associated with the moment may be communicable between photography equipment operated by the contractor and the content exchange component. The criteria may include proximity of the contractor to a location of the customer and a category of the contractor. At least part of the photography products created during the moment may be deliverable to the customer via the content exchange component. The customer may be associable with a customer profile storable in a database accessible via a network. The contractor may be associable with a contractor profile storable in the database. The contractor profile may include fields analyzable to determine the compliance with the criteria. At least some of the photography products may be storable in the database and accessible from the database. The moment may be capable of being opened prior to creating the customer profile to be associated with the customer. The photography products created during the moment may be deliverable after the moment is closed.

In another aspect, a commerce component may be provided to collect a fee relating to occurrence of the moment and purchasing at least some of the photography products created during the moment. The fee may include a first fee relating to the moment managed by the moment component. The fee may additionally include a second fee relating to purchase of at least some of the photography products created during the moment and deliverable via the content exchange component.

In another aspect, the content exchange component may include a local exchange module to deliver at least some of the photography products via an ad-hoc network communication between the frontend associated with the contractor and the frontend associated with the customer.

In another aspect, the content exchange component may include a relayed exchange module to deliver at least some of the photography products via a first relayed communication between the frontend associated with the contractor and the database and a second relayed communication between the database and the frontend associated with the customer.

According to an embodiment of this disclosure, a method is provided for matching a photography contractor and a customer using a photography matching system. The method may include (a) connecting the customer and a contractor using a matching component. The method may additionally include (b) controlling a moment between the customer and the contractor using a moment component, photography products created during the moment being viewable via an interface. The method may include (c) collecting a fee using a commerce component relating to occurrence of the moment and purchasing at least some of the photography products created during the moment. The method may also include (d) delivering the photography products using a content exchange component. Furthermore, the method may include (e) providing the interface to be interactively viewed using a frontend. The matching component, the moment component, the commerce component, and the content exchange component may be manipulable via the frontend. The photography products associated with the moment may be communicable between photography equipment operated by the contractor and the content exchange component. The customer may be associable with a customer profile storable in a database accessible via a network. The contractor may be associable with a contractor profile storable in the database. At least some of the photography products may be storable in the database and accessible from the database. The moment may be capable of being opened prior to creating the customer profile to be associated with the customer.

In another aspect, step (a) may additionally include (i) defining criteria for the contractor to be identified using a search module, (ii) identifying the contractor in compliance with the criteria using the search module, and (iii) providing a visualization of the contractor that is identified using a mapping module. The contractor profile may include fields analyzable to determine the compliance with the criteria. The criteria may include proximity of the contractor to a location of the customer and a category of the contractor. Step (b) may additionally include (iv) opening the moment between the customer and the contractor using an active moment module, (v) managing the moment that is opened using the active moment module, and (vi) closing the moment that has concluded using the active moment module. At least part of the photography products created during the moment may be deliverable to the customer via the content exchange component.

The fee may include a first fee relating to the moment managed by the moment component. The fee may additionally include a second fee relating to purchase of at least some of the photography products created during the moment and deliverable via the content exchange component. The fee may optionally include a commission of the fee collectable by the commerce component and payable to an operator of the system, the commission comprising a first portion of the first fee and a second portion of the second fee that are collected.

In another aspect, step (d) may additionally include (vii) delivering at least some of the photography products using a local exchange module via an ad-hoc network communication between the frontend associated with the contractor and the frontend associated with the customer. The photography products created during the moment may be deliverable after the moment is closed.

In another aspect, step (d) may additionally include (viii) delivering at least some of the photography products using a relayed exchange module via a first relayed communication between the frontend associated with the contractor and the database, and (ix) delivering at least some of the photography products using the relayed exchange module via a second relayed communication between the database and the frontend associated with the customer. The photography products created during the moment may be deliverable after the moment is closed.

Terms and expressions used throughout this disclosure are to be interpreted broadly. Terms are intended to be understood respective to the definitions provided by this specification. Technical dictionaries and common meanings understood within the applicable art are intended to supplement these definitions. In instances where no suitable definition can be determined from the specification or technical dictionaries, such terms should be understood according to their plain and common meaning. However, any definitions provided by the specification will govern above all other sources.

Various objects, features, aspects, and advantages described by this disclosure will become more apparent from the following detailed description, along with the accompanying drawings in which like numerals represent like components.

### BRIEF DESCRIPTION OF THE DRAWINGS

FIG. 1 is a block diagram view of a photography contracting system, according to an embodiment of this disclosure.

FIG. 2 is a block diagram view of a network communication structure, according to an embodiment of this disclosure.

FIG. 3 is a block diagram view of an illustrative computerized device, according to an embodiment of this disclosure.

FIG. 4 is a diagram view of an illustrative interface page of a frontend providing navigation and access to components of the system, according to an embodiment of this disclosure.

FIG. 5 is a diagram view of an illustrative interface page for defining a search criteria and viewing results, according to an embodiment of this disclosure.

FIG. 6 is a diagram view of an illustrative interface page for viewing photography products from a locally initiated moment, according to an embodiment of this disclosure.

FIG. 7 is a diagram view of an illustrative interface page for summarizing a moment, according to an embodiment of this disclosure.

FIG. 8 is a diagram view of an illustrative interface page for interacting with the commerce component and purchasing photography products from a closed moment, according to an embodiment of this disclosure.

FIG. 9 is a diagram view of an illustrative interface page for interacting with the feedback component, according to an embodiment of this disclosure.

FIG. 10 is a diagram view of an illustrative interface page for viewing photography products from closed moments, according to an embodiment of this disclosure.

FIG. 11 is a diagram view of an illustrative interface page for selecting availability for providing contractor services, according to an embodiment of this disclosure.

FIG. 12 is a diagram view of an illustrative interface page for reviewing and accepting a photoshoot moment by a contractor, according to an embodiment of this disclosure.

FIG. 13 is a diagram view of an illustrative interface page for interacting with the content exchange component by a contractor, according to an embodiment of this disclosure.

FIG. 14 is a flowchart view of an illustrative high level operation of various components, according to an embodiment of this disclosure.

FIG. 15 is a flowchart view of an illustrative operation of the matching component, according to an embodiment of this disclosure.

FIG. 16 is a flowchart view of an illustrative operation of the moment component, according to an embodiment of this disclosure.

FIG. 17 is a flowchart view of an illustrative operation of the commerce component, according to an embodiment of this disclosure.

FIG. 18 is a flowchart view of an illustrative operation of the content exchange component, according to an embodiment of this disclosure.

FIG. 19 is a flowchart view of an illustrative operation of the feedback component, according to an embodiment of this disclosure.

### DETAILED DESCRIPTION

The following disclosure is provided to describe various embodiments of a photography product contracting system. Skilled artisans will appreciate additional embodiments and uses of the present invention that extend beyond the examples of this disclosure. Terms included by any claim are to be interpreted as defined within this disclosure. Singular forms should be read to contemplate and disclose plural alternatives. Similarly, plural forms should be read to contemplate and disclose singular alternatives. Conjunctions should be read as inclusive except where stated otherwise.

Expressions such as “at least one of A, B, and C” should be read to permit any of A, B, or C singularly or in combination with the remaining elements. Additionally, such groups may include multiple instances of one or more element in that group, which may be included with other elements of the group. All numbers, measurements, and values are given as approximations unless expressly stated otherwise.

Various aspects of the present disclosure will now be described in detail, without limitation. In the following disclosure, a photography product contracting system will be discussed. Those of skill in the art will appreciate alternative labeling of the photography product contracting system as a photography service matching platform, photographer booking system, photograph system, media content contracting system, the invention, or other similar names. Similarly, those of skill in the art will appreciate alternative labeling of the photography product contracting system as a photography contracting method, photographer matching method, photography and photograph purchasing method, photography method, method, operation, the invention, or other similar names. Skilled readers should not view the inclusion of any alternative labels as limiting in any way.

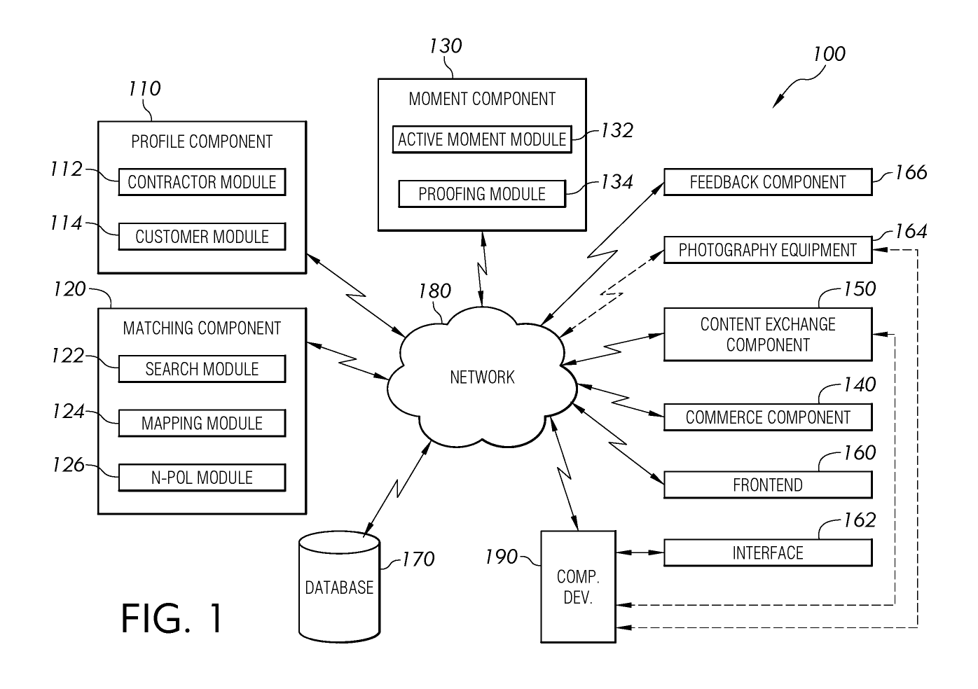

Referring now to FIGS. 1-19, the photography product contracting system will now be discussed in more detail. The photography product contracting system may include photography products; a server; database; profiles; frontend on which an interface may be viewed and manipulated; matching component, which may include a search module, mapping module, and optionally nearby photo opportunity location module; moment component, which may include an active moment module, locally initiated moment module, and proofing module; commerce component; content exchange component, which may include a local exchange module and relayed exchange module; feedback component, which may include a contractor review module and customer review module; and additional components that will be discussed in greater detail below. The photography product contracting system may operate one or more of these components interactively with other components to facilitate contracting between parties for photography services. In some embodiments, one or more component may be operated as a common runtime.

The system will now be discussed in greater detail. FIG. 1 highlights examples of the system, which may also be shown in other figures. The system may include various components through which operations and features of the disclosure. One or more of the components may be operated on the same or similar computerized devices. Additionally, one or more of the components may be operated via a common application or aspect of a system. It is not intended in this disclosure to require separate systems, applications, platforms, components, or devices for each of the discussed components. Transitions and handoffs between the various components discussed throughout this disclosure may be substantially seamless and virtually unnoticeable to a user.

Additionally, components may include one or more modules to assist with operation. The modules may be included as a subroutine, sub-operation, or other operable aspect of a component. Discussion of modules as includable aspects of components are not intended to limit the nature or construction of the components in any way.

Some common definitions that will be used throughout this disclosure will now be discussed. A user may be any person or entity capable of interacting with this system of this disclosure. Users may include customers, contractors, and others. Customers may be users that desire to search for and hire contractors, engage moment photography sessions with a hired contractor, and purchase photography products created during the moment photography session. Customers may additionally be referred to as consumers throughout this disclosure, without limitation.

An additional type of user includes a contractor, or party desiring to create photography products for a consumer during a moment photography session. The contractor may be alternatively referred to as a photography product contractor, without limitation. Users may be categorized based on photography equipment, skill, price, location, and/or other aspects. In one example, a contractor may be categorized via skill.

For example, the contractor may be categorized as an avid photographer, and may be expected to own a high-quality, network-connectable camera that will take photos better than the average smartphone. Network-connectable cameras may communicate with other electronic devices via integrated networking hardware, a network-enabled storage medium, an electronic connection to an external network-connected device such as a smartphone, or via another network connection technique that would be apparent to skilled artisans. An avid contractor may be a hobbyist, or a person that practices photography skills as a hobby. For example, an avid contractor may be expected to serve couples, solos, groups of all sizes that do not want to exclude anyone from the photo-op, general public that feels uncomfortable or does not want to compromise the quality of the moment by asking a random passerby, and/or simply people that do not want the endless selfie.

In another example, the contractor may be categorized as a skilled photographer, which may be expected to own a high-quality, network-connectable camera. A skilled contractor may be intended for customers that are in search of the personal touch of a photographer, including experience with focus, lighting, posture, standing advice, and other techniques known to a photographer. Skilled contractors may be expected to have some type of experience. In one example, a skilled photographer may possess years of photography experience, but does not practice photography as his or her primary source of income. Skilled contractors may elect to appear in the location as a skilled or avid contractor.

In an additional example, the contractor may be categorized as a professional photographer, which may be expected to have a degree or an established business. A professional photographer may be expected to own an array of professional photography equipment. For example, a contractor categorized as a professional may be involved in the photography industry, such as a photographer, assistant photographer, artistic director, teacher, editor, or otherwise employed in the photography business. In some cases, photography-related work may be the primary source of income for a professional photography contractor. A contractor categorized as a professional may choose to appear in the location as professional, skilled, and/or avid photographer. Skilled artisans will appreciate additional categorizations for contractors after having the benefit of this disclosure, which may be associated with more or less sophisticated talent and/or photography equipment.

Photography equipment 164 may be discussed throughout this disclosure, and may include a camera and its accessories. Photography equipment 164 may additionally include accessories and devices to facilitate communication of digital photography products over a network connection. Cameras may include native networking hardware, network-enabled storage media, or be connectable to a network-connected device such as a smartphone or tablet with WiFi or mobile data. An identifiable camera strap may be used with the photography equipment to assist customers with identifying contractors associated with this disclosure.

In some embodiments, a list of acceptable, compatible, and/or otherwise desirable photography equipment may be provided to existing and prospective contractors. In some situations, unlisted photography equipment may additionally be permitted for use with this disclosure. In additional embodiments, photography equipment may include an integrated camera of an electronic device.

Throughout this disclosure, a moment may be discussed as a photography session or photo opportunity. Moments may be intended to be short term, without limitation. For example, a moment may be intended to last in average of 5 to 10 minutes, and may be variable at the discretion of the contractor. Optionally, a timer may be included to track the time elapsed during a moment. Contractors may elect to create as many photography products as reasonably necessary during a moment. Photography products created during a moment may be uploaded, optionally with watermark protection, to a central database through which a customer may view and purchase the photography products.

Photography products may be discussed throughout this disclosure as media and other content created during a moment photography session. Photography products may include photographs, snaps, pictures, animated pictures, videos, and other media capable of being captured using photography equipment. Photography products may include digital photographs, without limitation.

The database will now be discussed in greater detail. FIG. 1 highlights examples of the database, which may also be shown in other figures. Information relating to this disclosure may be recorded to, stored in, managed by, retrieved from, and/or otherwise used via a database. The database 170 may include multiple information repositories, and may be spanned across various physical storage media. For example, the database 170 may include repositories for profile information, photography product storage, and other information. Physical media on which the database 170 may be stored can maintained at a common location or over multiple networked locations. Storage of information via the database 170 may be managed, for example, to provide storage of photography products for a consumer to purchase for a definable time. The time for which photography products and other information is maintained may be manually and/or automatically, which may be determinable respective to factors such as cost of storage.

The profile component will now be discussed in greater detail. FIG. 1 highlights examples of the profiles and profile component, which may also be shown in other figures. The profile component 110 may assist with gathering and managing information relating to users. The profile component 110 may include modules to assist with creating and providing access to profiles and their information. For example, the profile component 110 may include a contractor module 112 and a customer module 114.

The contractor module 112 may assist with managing and providing access to associated contractors. For example, the contractor module 112 may assist contractors with opening an account, choosing or being assigned a categorization, and commercial transactional information. At least some of the information may be designated by checking appropriate boxes at the time of registration, providing a picture ID and/or selfie, providing a bank or other financial account, providing a mailing address and other contact information, and/or specifying photography equipment used by the contractor. Some contractors, such as high-level categorized contractors, may additionally be requested or required to provide proof of professional photography credentials, business ownership, or other information.

The customer module 114 may assist with managing and providing access to associated customers. Information associated with a customer profile may be used to provide contact information and forms of payment.

The profile component 110 may assist new customers, contractors, and other users with creating a profile. For example, a new customer or contractor may sign up by providing a username, email address, and/or password. Skilled artisans will appreciate that an email address may be used as a username in some cases. An optional profile picture may be provided.

The profile component 110 may additionally assist users with managing a profile. In one embodiment, the profile component 110 may assist with resetting a forgotten password. For example, the profile component 110 may provide a link for password resetting. Engaging the link may send an email reset link to the user.

The frontend will now be discussed in greater detail. FIG. 1 highlights examples of the frontend, which may also be shown in other figures. The frontend 160 may provide the interactivity experienced by customers and contractors using the system. The frontend 160 may be operated using a computerized device 190. In some embodiments, the frontend 160 may be acquired through an application marketplace. For example, the frontend 160 may provide information to users via an interface 162 displayable via a computerized device 190. The frontend 160 may additionally receive input from the customer or contractor computerized device 190. The frontend 160 may adapt the interface to display features and/or options appropriate for the type of user engagement detected. For example, the frontend 160 may determine that a customer is accessing the interface 162. The frontend 160 may display features of the interface 162 applicable for customer interaction, such as features to search for contractors or purchase photography products.

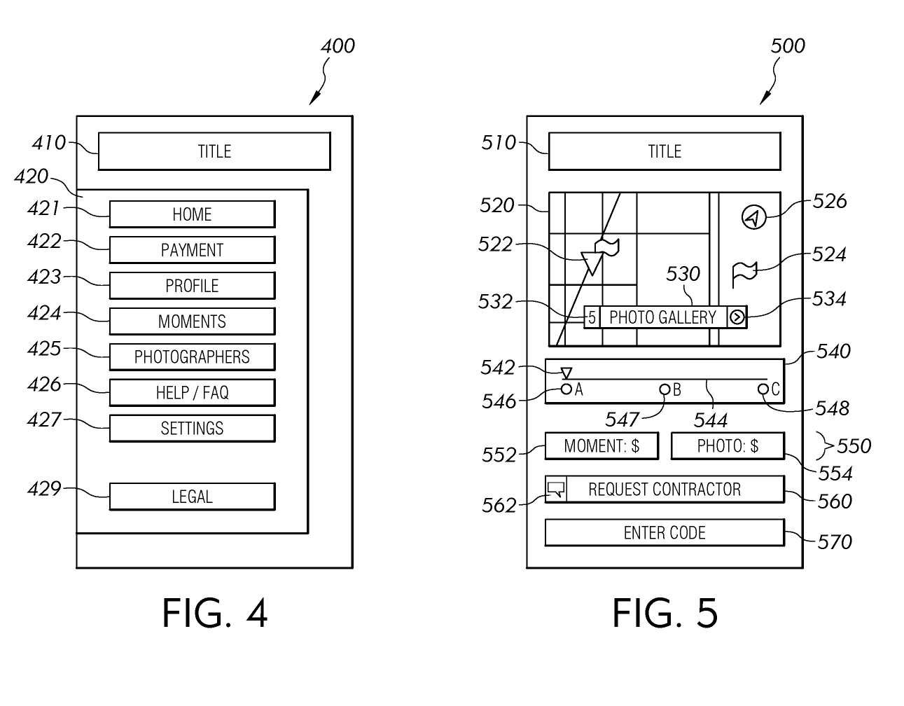

The interface will now be discussed in greater detail. FIGS. 1 and 4-13 highlight examples of the interface, which may also be shown in other figures. The interface 162 may provide information to customers and contractors to facilitate contracting of services. The interface 162 may include various pages viewable by a user, which may allow a user to interact with the various components of this disclosure. As discussed above, the interface 162 may be adaptable respective to a user. The interface 162 may be viewable through operation of the frontend 160. Examples of interface features will be discussed in greater detail along with FIGS. 4-13.

The matching component will now be discussed in greater detail. FIGS. 1 and 5 highlight examples of the matching component, which may also be shown in other figures. The matching component 120 may assist with matching a customer and contractor to engage in a moment. The matching component 120 may include a search module 122 and a mapping module 124. The matching component 120 may optionally also include a nearby photo opportunity location (“N-POL”) module 126, which may highlight attractions and areas of interest. The matching component 120 may additionally assist with establishing a locally initiated moment.

The matching component 120 may be manipulable via an interface 162. For example, a customer may search for, locate, and request a contractor using the matching component. A customer may define criteria for a desired contractor, for example, a category for the contractor. The customer may initiate a search for contractors matching the criteria using the search module 122, for example, selecting an option to request a contractor via the interface 162. Once the request is submitted, a notification may be provided to the customer indicating that the search has begun. An animation or other visual feedback may be provided to the customer to indicate the search is still being performed. Additionally, the user may be provided an alert once a contractor is located, for example, via push notification.

Potential contractors within a searchable location may be visually indicated to the customer using the mapping module 124. For example, contractors that may possibly be matched may be displayed on a map generated by the mapping module 124. The map may be viewable via the interface 162. Other areas of interest may additionally be displayed on the map, for example, N-POL locations provided by a N-POL module.

A contractor may be given the option to accept a requested moment. The contractor may be given a time limit in which to accept the moment, after which the opportunity for that contractor may expire. If a contractor accepts the moment, information may be provided to the customer to assist with coordination. At least part of the provided information may be associated with a profile. In some embodiments, a default message may be provided to the customer and/or contractor to assist with meeting and beginning the moment. In one embodiment, customers and contractors may be matched automatically. In an additional embodiment, request to match a customer with a contractor can be cancelled.

The nearby photo opportunity location (“N-POL”) module 126 will now be discussed in greater detail. The N-POL module 126 may provide notifications to assist customers, for example, tourists in an unfamiliar city, to identify points of interest in their geographical location where a significant number of the available contractors may be concentrated. Information used with the N-POL module 126 may be locally generated, licensed, imported, sourced from a third-party database, or otherwise acquired. Skilled artisans will appreciate that inclusion of the N-POL module 126 does not require the contractor, customer, system operator, or other party associated with the system to generate the content provided by the N-POL module. The N-POL module 126 may assist contractors with setting up moments and selling photography products created during the moments. An approximate distance from the location of the customer and/or contractor to the N-POL may be provided via the interface 162. An example listing via the N-POL feature may include the Chicago Symphony Orchestra, providing a description such as, “The sound of this world class orchestra deserves all the accolades.” In another example listing via the N-POL feature, Chicago's Cloud Gate may be listed with a description such as, “Anish Kapoor's bean-shaped sculpture is considered to be the new centerpiece of Millennium Park.”

The locally initiated moment will now be discussed in greater detail. A locally initiated moment may provide an alternative avenue for a contractor and customer to initiate a moment through the matching component 120. For example, a customer may identify a contractor as being available for photography contracting services, such as by spotting an identifying camera strap. The contractor and customer may create photography products similar to as if they were matched via the search module 122 of the matching component 120. At the end of the locally initiated moment, the contractor may provide the customer with a moment code. The customer could later download the frontend 160 and/or go online and purchase the photography products from the locally initiated moment. Unique moment codes may be assigned to each locally initiated moment.

The moment component will now be discussed in greater detail. FIG. 1 highlights examples of the moment component, which may also be shown in other figures. The moment component 130 may assist with coordinating and conducting a moment. The moment component may include an active moment module 132 and a proofing module 134 to assist with managing a moment. Photography products may be created during the moment. Once the moment is closed, created photography products may be shared with or otherwise made available to a customer.

The active moment module 132 may assist the contractor with opening, conducting, and closing a moment. The active moment module 132 may additionally assist a customer with being aware of when the present moment is occurring. In one example, a moment may be opened once a customer and contractor is matched. The active moment module 132 may provide the customer with a contractor name and profile photo, and may optionally provide other information associated with the contractor. A messaging interface may be provided through which the customer and contractor can communicate, for example, before meeting in person. The customer and contractor may interact during the moment to create the desired number of photography products, after which the moment may be closed.

The contractor may then interact with the proofing module 134 of the moment component 130 to select the photographs from the moment to share with the customer. The contractor may use the proofing module 134 to exclude blurry or otherwise undesirable photography products. In some embodiments, the proofing module 134 may substantially automate selection of photography products to share with the customer. In some embodiments, the proofing module 134 may be provided by the photography equipment 164. An automated proofing module may select all photography products from the moment to share with the customer.

The selected photography products may then be shared with the customer for potential purchase. The selected photography products may be provided to the customer in a gallery view, for example. The customer may be provided with an action area to “Buy this moment for $X.XX”. The price may be calculated to include a moment fee, photography product fee, and optionally transactional or commission fees.

Customers may indicate the photography products desired for purchase. Optionally, the photography products from the moment may be provided to the customer with all or substantially all photography products selected. The customer may then deselect the photography products that the customer does not wish to purchase. Photography products may be enlarged, zoomed, and otherwise manipulated by the customer when deciding whether to purchase.

To prevent or deter theft of photography products created during a moment, an overlay watermark may be placed on top of the photography products. This overlay watermark may be removed upon purchase.

The commerce component will now be discussed in greater detail. FIG. 1 highlights examples of the commerce component 140, which may also be shown in other figures. The commerce component 140 may assist with paying for purchased moment and photography products. Payment information may be collected from customers using the commerce component 140 for current and optionally future payments. The commerce component 140 may feature and option to remember payment information, which may help to speed up future purchases from new and/or past moments.

The commerce component 140 may store payment information associated with a customer, for example, credit card information, bank account information, Apple Pay information, and/or other payment details. The payment information may be stored in the database 170, which may be connected over a network 180. Additionally, the commerce component 140 may store information for providing revenue to the contractors, for example, bank account information. The payment information for contractors may additionally be stored in the database 170.

The commerce component 140 may calculate a fee payable to purchase the photography products from a moment. The fee may include a first fee relating to the moment managed by the moment component 130. This fee may be based on the category of the contractor. For example, a higher first fee may be charged for the moment using a professional contractor as opposed to a lower-categorized avid contractor. The fee may additionally include a second fee relating to purchase of at least some of the photography products created during the moment and deliverable via the content exchange component 150. The second fee may be variable reflecting the category of the contractor, number of photographs purchased, and/or other variables. The fee may optionally include a commission of the fee collectable by the commerce component 140 and payable to an operator of the system. The commission may be percentage based, fixed, and/or otherwise calculated. The commission may be and/or include a transaction fee, without limitation. The commission may include a first portion of the first fee and a second portion of the second fee that are collected, which may be determined as a percentage or as a fixed amount respective to the first and second fees.

Payment transactions may be processed using the commerce component 140. Payments may be processed using a connected and/or integrated credit card gateway, for example. Once payment is successfully processed, purchased photography products may be modified to remove any watermarks. Purchased photography products may be saved in a library available to the user via the content exchange component 150. In one embodiment, purchased photography products may be transferred or copied to a photo gallery located on the customer computerized device 190. In an additional embodiment, a social media or content sharing application operable on the customer's computerized device may be offered the purchased photography products from the photo gallery. A confirmation may be provided once the purchase is completed. Unpurchased photography products may be held for a definable time, after which the unpurchased photography products may expire.

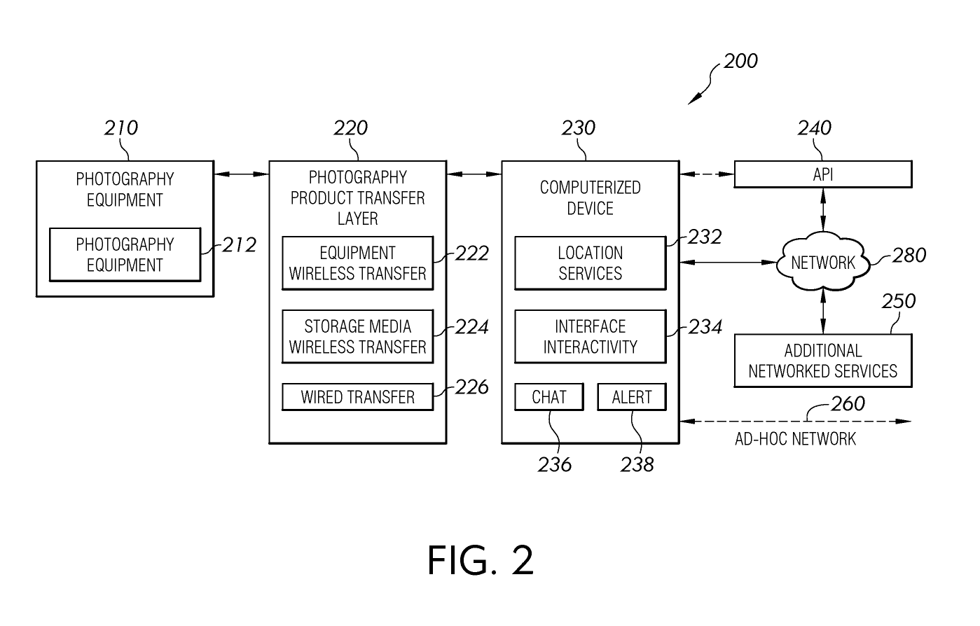

The content exchange component will now be discussed in greater detail. FIGS. 1-2 highlight examples of the content exchange component, which may also be shown in other figures. The content exchange component 150 may assist with delivering photography products from a moment to a customer. The content exchange component 150 may be configured to operate using a variety of network connection setups.

For example, the content exchange component 150 may be configured to share and/or deliver photography products using a direct data connection between a contractor's computerized device and the customer's computerized device. In this configuration, the content exchange component 150 may include a local exchange module to deliver at least some of the photography products via an ad-hoc network communication between the frontend associated with the contractor and the frontend associated with the customer.

In another example, the content exchange component 150 may be configured to share and/or deliver photography products using a relayed data connection. In this configuration, the content exchange component may include a relayed exchange module to deliver at least some of the photography products via a first relayed communication between the frontend associated with the contractor and the database 170 and a second relayed communication between the database 170 and the frontend associated with the customer. The photography products may be stored in the database for a definable amount of time.

The feedback component will now be discussed in greater detail. FIG. 1 highlights examples of the feedback component 166, which may also be shown in other figures. The feedback component 166 may prompt a user to provide feedback on the moment, photography products from the moment, and other party to the contracted service. Feedback may include friendliness, quality, and/or additional opinions.

The feedback component 166 may include a contractor review component, through which a customer may provide feedback about a contractor. Feedback may include friendliness, professionalism, quality of photography products created, and/or other feedback. The feedback component 166 may additionally include a customer review module, through which a contractor may provide feedback about the customer. Feedback may include friendliness, respectfulness of contractor time, photography products purchased, and/or other feedback.

A threshold feedback level may be defined by the feedback component 166. For example, if feedback is provided below the threshold feedback level, the user may be requested to provide additional feedback details. In some embodiments, feedback less than an acceptable level may result in revoking a contractor's and/or customer's access to future moments and contracted services.

Additional optional features may be provided. For example, a share feature may be included, allowing a customer to directly share purchased photography products. Third-party services may also be integrated into the matching component, for example, providing a list of places nearby within the frontend that are great for pictures, selfies, and/or group photos. Optionally, the customer can select to be notified when N-POLs or contractors are nearby. Permission may be asked prior to monitoring location information.

Referring now to block diagram 200 of FIG. 2, an illustrative network communication structure will be discussed. Skilled artisans will appreciate that the illustrative network communication structure of block diagram 200 is provided as an example, and is not intended to limit the possible communication structure between the components of this disclosure in any way. The communication structure may facilitate the communication of electronic information between photography equipment 210 and a computerized device 230 via a photography product transfer layer 220.

The photography equipment 210 may include hardware to facilitate communication of created photography products with a computerized device 230. For example, the photography equipment may include a wireless radio and/or network interface controller. In this example, the photography equipment 210 may communicate created photography products via an equipment wireless transfer operation 222 of the photography product transfer layer 220 with the computerized device 230.

In another example, the photography equipment may include photography media 212 that may include a wireless radio and/or network interface controller. In this example, the photography equipment 210 may communicate created photography products using the photography media 212 via a storage media wireless transfer operation 224 of the photography product transfer layer 220 with the computerized device 230.

In an additional example, the photography equipment 210 may include a connection interface to attach a data cable between the photography equipment 210 and the computerized device 230. In this example, the photography equipment 210 may communicate created photography products via a wired transfer operation 226 of the photography product transfer layer 220 with the computerized device 230.

The computerized device 230 may include location services 232, which may assist with identifying a location of a user operating the computerized device 230. The computerized device 230 may additionally include interface interactivity features 234 that may assist the customer and/or contractor interacting with the components of this disclosure. A chat feature 236 may be included to assist with communication between various users. Additionally, an alert feature 238 may be provided by the computerized device 230 to inform a user of a detected condition, for example, proximity to N-POLs.

The computerized device 230 may communicate with an application programming interface (“API”) 240. The API 240 may be operated directly on the computerized device 230, over a network 280, or otherwise. The API 240 may facilitate development and integration of the system described by this disclosure with additional applications and other products. Access to features of the API 240 may be controlled by an administrator, which may be selectively enabled according to customer identity, licensing terms, or another condition. The API 240 may additionally manage access restrictions among connected components and/or additional applications. The API 240 may include a library with specifications for routines, data structures, object classes, variables, and other aspects for application development.

The computerized device 230 may be communicably connected to a network 280, through which the user may interact with one or more additional networked services 250 of this disclosure. The computerized device 230 may optionally establish an ad-hoc network connection 260 with a computerized device of another user.

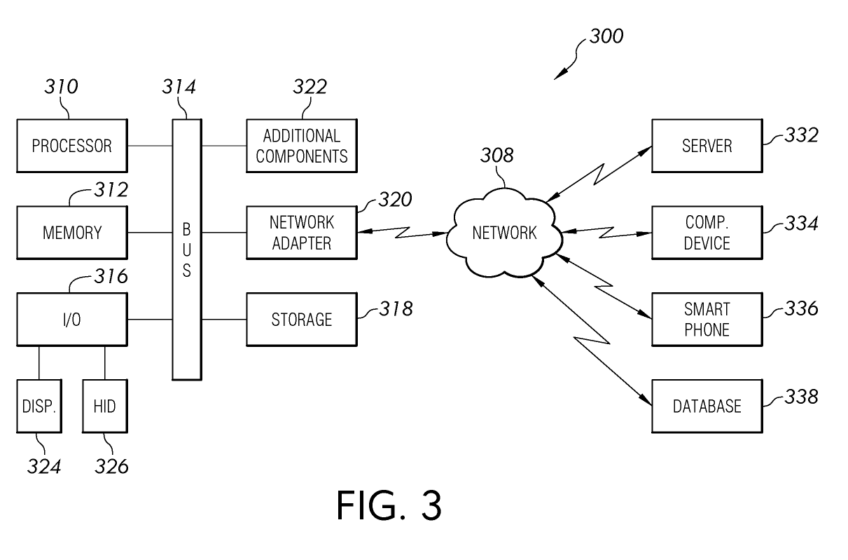

Referring now to FIG. 3, an illustrative computerized device will be discussed, without limitation. Various aspects and functions described in accord with the present disclosure may be implemented as hardware or software on one or more illustrative computerized devices 300 or other computerized devices. There are many examples of illustrative computerized devices 300 currently in use that may be suitable for implementing various aspects of the present disclosure. Some examples include, among others, network appliances, personal computers, workstations, mainframes, networked clients, servers, media servers, application servers, database servers and web servers. Other examples of illustrative computerized devices 300 may include mobile computing devices, cellular phones, smartphones, tablets, video game devices, personal digital assistants, network equipment, devices involved in commerce such as point of sale equipment and systems, such as handheld scanners, magnetic stripe readers, bar code scanners and their associated illustrative computerized device 300, among others. Additionally, aspects in accord with the present disclosure may be located on a single illustrative computerized device 300 or may be distributed among one or more illustrative computerized devices 300 connected to one or more communication networks.

For example, various aspects and functions may be distributed among one or more illustrative computerized devices 300 configured to provide a service to one or more client computers, or to perform an overall task as part of a distributed system. Additionally, aspects may be performed on a client-server or multi-tier system that includes components distributed among one or more server systems that perform various functions. Thus, the disclosure is not limited to executing on any particular system or group of systems. Further, aspects may be implemented in software, hardware or firmware, or any combination thereof. Thus, aspects in accord with the present disclosure may be implemented within methods, acts, systems, system elements and components using a variety of hardware and software configurations, and the disclosure is not limited to any particular distributed architecture, network, or communication protocol.

FIG. 3 shows a block diagram of an illustrative computerized device 300, in which various aspects and functions in accord with the present disclosure may be practiced. The illustrative computerized device 300 may include one or more illustrative computerized devices 300. The illustrative computerized devices 300 included by the illustrative computerized device may be interconnected by, and may exchange data through, a communication network 308. Data may be communicated via the illustrative computerized device using a wireless and/or wired network connection.

Network 308 may include any communication network through which illustrative computerized devices 300 may exchange data. To exchange data via network 308, systems and/or components of the illustrative computerized device 300 and the network 308 may use various methods, protocols and standards including, among others, Ethernet, Wi-Fi, Bluetooth, TCP/IP, UDP, HTTP, FTP, SNMP, SMS, MMS, SS7, JSON, XML, REST, SOAP, RMI, DCOM, and/or Web Services, without limitation. To ensure data transfer is secure, the systems and/or modules of the illustrative computerized device 300 may transmit data via the network 308 using a variety of security measures including TSL, SSL, or VPN, among other security techniques. The illustrative computerized device 300 may include any number of illustrative computerized devices 300 and/or components, which may be networked using virtually any medium and communication protocol or combination of protocols.

Various aspects and functions in accord with the present disclosure may be implemented as specialized hardware or software executing in one or more illustrative computerized devices 300, including an illustrative computerized device 300 shown in FIG. 3. As depicted, the illustrative computerized device 300 may include a processor 310, memory 312, a bus 314 or other internal communication system, an input/output (I/O) interface 316, a storage system 318, and/or a network communication device 320. Additional devices 322 may be selectively connected to the computerized device via the bus 314. Processor 310, which may include one or more microprocessors or other types of controllers, can perform a series of instructions that result in manipulated data. Processor 310 may be a commercially available processor such as an ARM, x86, Intel Core, Intel Pentium, Motorola PowerPC, SGI MIPS, Sun UltraSPARC, or Hewlett-Packard PA-RISC processor, but may be any type of processor or controller as many other processors and controllers are available. As shown, processor 310 may be connected to other system elements, including a memory 312, by bus 314.

The illustrative computerized device 300 may also include a network communication device 320. The network communication device 320 may receive data from other components of the computerized device to be communicated with servers 332, databases 334, smart phones 336, and/or other computerized devices 338 via a network 308. The communication of data may optionally be performed wirelessly. More specifically, without limitation, the network communication device 320 may communicate and relay information from one or more components of the illustrative computerized device 300, or other devices and/or components connected to the computerized device 300, to additional connected devices 332, 334, 336, and/or 338. Connected devices are intended to include, without limitation, data servers, additional computerized devices, mobile computing devices, smart phones, tablet computers, and other electronic devices that may communicate digitally with another device. In one example, the illustrative computerized device 300 may be used as a server to analyze and communicate data between connected devices.

The illustrative computerized device 300 may communicate with one or more connected devices via a communications network 308. The computerized device 300 may communicate over the network 308 by using its network communication device 320. More specifically, the network communication device 320 of the computerized device 300 may communicate with the network communication devices or network controllers of the connected devices. The network 308 may be, for example, the internet. As another example, the network 308 may be a WLAN. However, skilled artisans will appreciate additional networks to be included within the scope of this disclosure, such as intranets, local area networks, wide area networks, peer-to-peer networks, and various other network formats. Additionally, the illustrative computerized device 300 and/or connected devices 332, 334, 336, and/or 338 may communicate over the network 308 via a wired, wireless, or other connection, without limitation.

Memory 312 may be used for storing programs and/or data during operation of the illustrative computerized device 300. Thus, memory 312 may be a relatively high performance, volatile, random access memory such as a dynamic random access memory (DRAM) or static memory (SRAM). However, memory 312 may include any device for storing data, such as a disk drive or other non-volatile storage device. Various embodiments in accord with the present disclosure can organize memory 312 into particularized and, in some cases, unique structures to perform the aspects and functions of this disclosure.

Components of illustrative computerized device 300 may be coupled by an interconnection element such as bus 314. Bus 314 may include one or more physical busses (for example, busses between components that are integrated within a same machine), but may include any communication coupling between system elements including specialized or standard computing bus technologies such as USB, Thunderbolt, SATA, FireWire, IDE, SCSI, PCI and InfiniBand. Thus, bus 314 may enable communications (for example, data and instructions) to be exchanged between system components of the illustrative computerized device 300.

The illustrative computerized device 300 also may include one or more interface devices 316 such as input devices, output devices and combination input/output devices. Interface devices 316 may receive input or provide output. More particularly, output devices may render information for external presentation. Input devices may accept information from external sources. Examples of interface devices include, among others, keyboards, bar code scanners, mouse devices, trackballs, magnetic strip readers, microphones, touch screens, printing devices, display screens, speakers, network interface cards, etc. The interface devices 316 allow the illustrative computerized device 300 to exchange information and communicate with external entities, such as users and other systems.

Storage system 318 may include a computer readable and writeable nonvolatile storage medium in which instructions can be stored that define a program to be executed by the processor. Storage system 318 also may include information that is recorded, on or in, the medium, and this information may be processed by the program. More specifically, the information may be stored in one or more data structures specifically configured to conserve storage space or increase data exchange performance. The instructions may be persistently stored as encoded bits or signals, and the instructions may cause a processor to perform any of the functions described by the encoded bits or signals. The medium may, for example, be optical disk, magnetic disk or flash memory, among others. In operation, processor 310 or some other controller may cause data to be read from the nonvolatile recording medium into another memory, such as the memory 312, that allows for faster access to the information by the processor than does the storage medium included in the storage system 318. The memory may be located in storage system 318 or in memory 312. Processor 310 may manipulate the data within memory 312, and then copy the data to the medium associated with the storage system 318 after processing is completed. A variety of components may manage data movement between the medium and integrated circuit memory element and does not limit the disclosure. Further, the disclosure is not limited to a particular memory system or storage system.

Although the above described illustrative computerized device is shown by way of example as one type of illustrative computerized device upon which various aspects and functions in accord with the present disclosure may be practiced, aspects of the disclosure are not limited to being implemented on the illustrative computerized device 300 as shown in FIG. 3. Various aspects and functions in accord with the present disclosure may be practiced on one or more computers having less or more components than that shown in FIG. 3. For instance, the illustrative computerized device 300 may include specially-programmed, special-purpose hardware, such as for example, an application-specific integrated circuit (ASIC) tailored to perform a particular operation disclosed in this example. While another embodiment may perform essentially the same function using several general-purpose computing devices running Windows, Linux, Unix, Android, iOS, MAC OS X, or other operating systems on the aforementioned processors and/or specialized computing devices running proprietary hardware and operating systems.

The illustrative computerized device 300 may include an operating system that manages at least a portion of the hardware elements included in illustrative computerized device 300. A processor or controller, such as processor 310, may execute an operating system which may be, among others, an operating system, one of the above mentioned operating systems, one of many Linux-based operating system distributions, a UNIX operating system, or another operating system that would be apparent to skilled artisans. Many other operating systems may be used, and embodiments are not limited to any particular operating system.

The processor and operating system may work together define a computing platform for which application programs in high-level programming languages may be written. These component applications may be executable, intermediate (for example, C# or JAVA bytecode) or interpreted code which communicate over a communication network (for example, the Internet) using a communication protocol (for example, TCP/IP). Similarly, aspects in accord with the present disclosure may be implemented using an object-oriented programming language, such as JAVA, C, C++, C#, Python, PHP, Visual Basic .NET, JavaScript, Perl, Ruby, Delphi/Object Pascal, Visual Basic, Objective-C, Swift, MATLAB, PL/SQL, OpenEdge ABL, R, Fortran or other languages that would be apparent to skilled artisans. Other object-oriented programming languages may also be used. Alternatively, assembly, procedural, scripting, or logical programming languages may be used.

Additionally, various aspects and functions in accord with the present disclosure may be implemented in a non-programmed environment (for example, documents created in HTML5, HTML, XML, CSS, JavaScript, or other format that, when viewed in a window of a browser program, render aspects of a graphical-user interface or perform other functions). Further, various embodiments in accord with the present disclosure may be implemented as programmed or non-programmed elements, or any combination thereof. For example, a web page may be implemented using HTML while a data object called from within the web page may be written in C++. Thus, the disclosure is not limited to a specific programming language and any suitable programming language could also be used.

An illustrative computerized device included within an embodiment may perform functions outside the scope of the disclosure. For instance, aspects of the system may be implemented using an existing commercial product, such as, for example, Database Management Systems such as a SQL Server available from Microsoft of Redmond, Wash., Oracle Database or MySQL from Oracle of Redwood City, Calif., or integration software such as WebSphere middleware from IBM of Armonk, N.Y.

Illustrative interface pages will now be described, without limitations. Those of skill in the art will appreciate that the following illustrative interface pages are provided to clearly describe a model configuration of features providable by the interface, and are not intended to limit this disclosure in any way. The interface may be viewable and manipulable via a frontend operated on a computerized device. Skilled artisans will appreciate additional interface pages, along with variations of the discussed interface pages, that are consistent with the scope and spirit of this disclosure.

Referring now to diagram 400 of FIG. 4, an illustrative interface page providing navigation and access to components of the system will be described, without limitation. The interface page of diagram 400 may be the main screen of the interface, displayable after a customer signs into the interface. This interface page may include a title 410. Also, if any chats are active, a chat icon might appear in the top right of the title bar. The interface page may additionally include a menu 420, with buttons to navigate to various interface pages. The menu 420 may be accessible from various interface pages.

The menu 420 may include a home button 421, which may direct a customer to a home page. The menu may include a payment button 422, which may direct a customer to a page to access and/or edit payment details. The menu may include profile button 423, which may direct a customer to a page to access and/or edit profile information. The menu may include a moments button 424, which may direct a customer to a page to view current and past moments. The menu may include a photographers button 425, which may direct a user to a page to view information about contractors from prior moments. The menu may include a help/FAQ button 426, which may provide the customer with information about the components and other aspects of this disclosure. The menu may include a settings button 427, which may direct the customer to a page to view and/or modify settings of the frontend or other components. The menu may include a legal button 429, which may display terms, conditions, privacy policy, and other documentation.

Referring now to diagram 500 of FIG. 5, an illustrative interface page for defining a search criteria and viewing results will be described, without limitation. The page shown in diagram 500 may provide interaction with the matching component for a customer. The interface page may include a title 510. The interface page may additionally include a map area 520. In one example, map area 520 may occupy approximately the upper two-thirds of the page, without limitation. The map area 520 may be zoomed, rotated, moved, pinched, and/or otherwise manipulated. The map area 520 may default to show the user at the center of the map. Contractor icons 522 may be displayed on the map area 520, indicating contractors for potential matching. Additionally, N-POL icons 524 may be provided. A compass icon 526 may be included to assist with orientation.

If no contractors are nearby, a ghosted contractor icon may be displayed. Engaging the ghosted contractor icon may state that no contractors are currently available, offering to request to be notified when one is nearby and available. If such a request is made, the customer may be notified later when a contractor becomes available.

A photo gallery button 530 optionally may be provided in the map area, by which a customer may access his or her photo gallery. A gallery indication 532 may be included to quickly inform a user with information about the gallery. Additionally, a gallery quick link 534 may be included to provide quick access to the photo gallery.

A criteria selection area 540 may be provided to define criteria for contractors to be searched. In this example, the criteria selection area 540 includes a category marker 542 associated with a category slider 544, which may be manipulated by the customer to select a photographer category. In the interest of clarity, three categories 546, 547, 548 are illustrated, corresponding with increasing levels of skill and photography equipment.

Manipulation of the category marker 542 may change the selected category and associated rates 550. The moment rate display 552 may be updated to reflect the rate associated with the selected category. Similarly, the photography product rate 554 may be updated to reflect the rate associated with the selected category. When the category marker changes, the prices for the skill level may change. Additionally, When the category marker changes, the contractor icons 522 may update to only display that level. A default category may be defined.

A request contractor button 560 may be included to request matching with an available contractor. A contractor chat button 562 may also be provided to allow quick access to a chat interface with a requested contractor. Alternatively, a customer may enter a moment code in the locally initiated moment field 570 for a locally initiated moment.

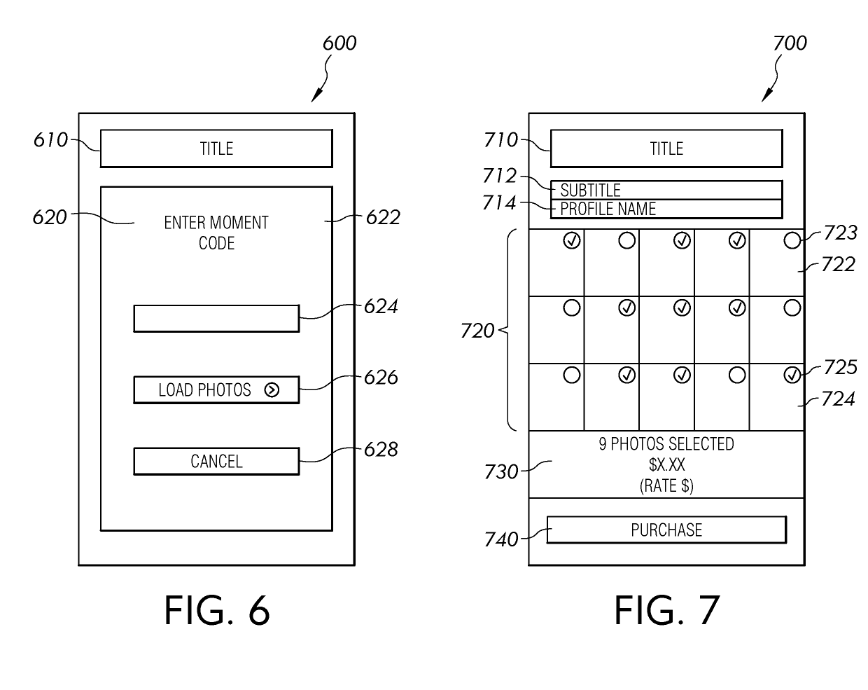

Referring now to diagram 600 of FIG. 6, a diagram view of an illustrative interface page for viewing photography products from a locally initiated moment will be described, without limitation. The page shown in diagram 600 may provide interaction with the moment component to access a locally initiated moment. This interface page may include a title 610. The page may additionally include a moment code section 620 with a moment code section title 622. A moment code field 624 may be provided to enter a moment code for a locally initiated moment. Once the moment code is entered, a customer may engage an access button 626 to load photography products from the locally initiated moment. A cancel button 628 may additionally be provided to cancel the import of a locally initiated moment.

Referring now to diagram 700 of FIG. 7, a diagram view of an illustrative interface page for summarizing a moment will be described, without limitation. The page shown in diagram 700 may provide interaction with the moment component. This interface page may include a title 710. The page may additionally include a subtitle 712 and profile name 714. A moment gallery 720 may be provided to display photography products 722, 724, and others created during the current moment. A selection icon 723, 725 may be provided with photography products. For illustrative purposes, selection icon 723 is display as being unselected and selection icon 725 is displayed as being selected for purchase. A summary of fees 730 and purchase button 740 may also be provided.

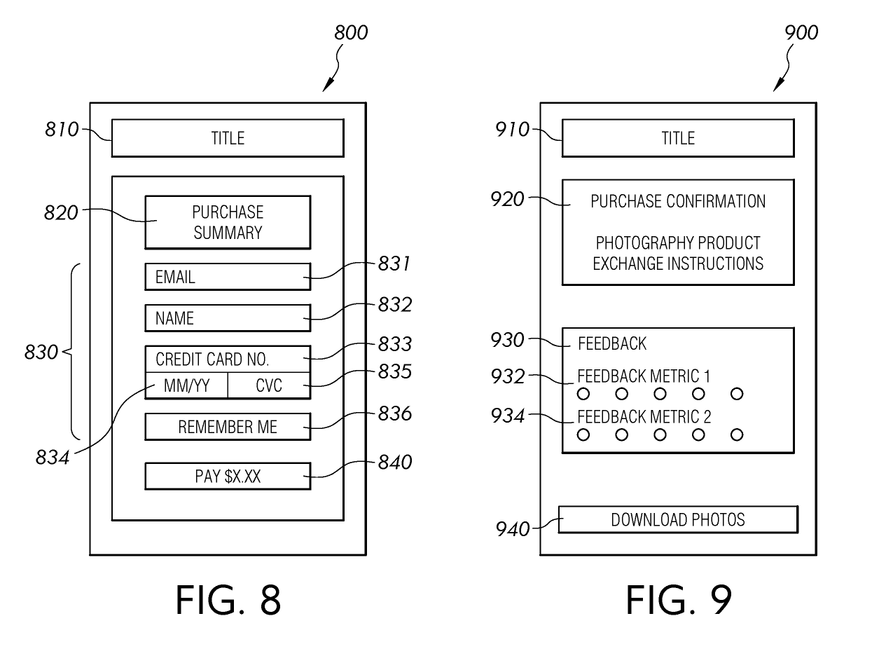

Referring now to diagram 800 of FIG. 8, a diagram view of an illustrative interface page for interacting with the commerce component and purchasing photography products from a closed moment will be described, without limitation. The page shown in diagram 800 may provide interaction with the commerce component. This interface page may include a title 810. A purchase summary 820 may additionally be included, which may summarize the fees associated with the moment, selected photography products, commission, and/or other fees. A payment information section 830 may be provided to collect payment information. Possible payment information may include email 831, name 832, credit card number 833, credit card expiration 834, and credit card security code 835. A remember option 836 may be provided to store payment information for the customer. The payment information may be stored in the database and associated with the customer profile. A pay button 840 may be provided to submit payment for processing. The pay button 840 may optionally include dynamic information relating to the fees.

Referring now to diagram 900 of FIG. 9, a diagram view of an illustrative interface page for interacting with the feedback component will be described, without limitation. The page shown in diagram 900 may provide interaction with the feedback component. This interface page may include a title 910. The page may also include a purchase confirmation message 920. The purchase confirmation message 920 may additionally include instructions to retrieve purchased photography products. A feedback section 930 may be provided to request feedback for an experience. The feedback section may include questions and/or ratings for multiple feedback metrics 932, 934. Customers may be provided with a download photos button 940 to retrieve purchased photography products.

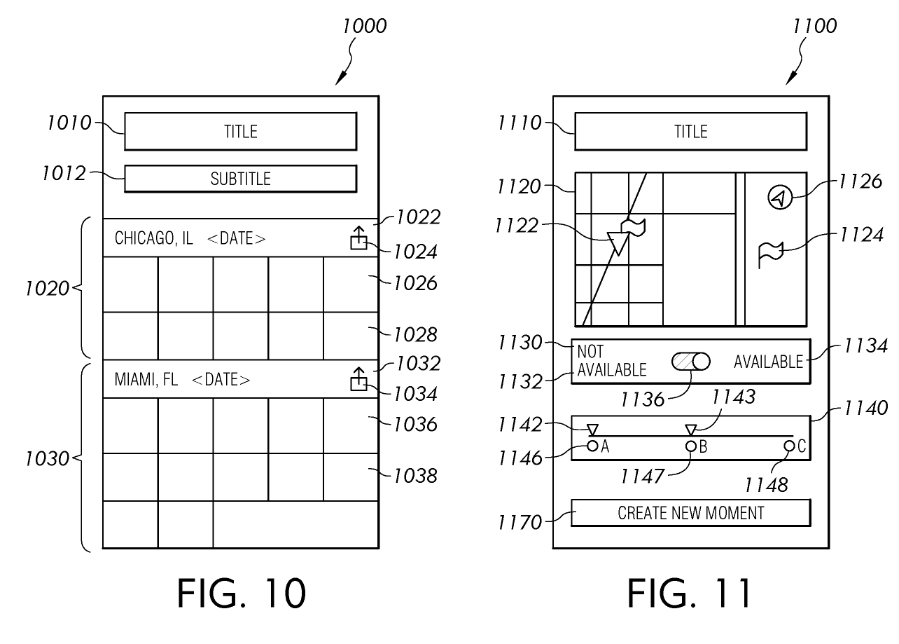

Referring now to diagram 1000 of FIG. 10, a diagram view of an illustrative interface page for viewing photography products from closed moments will be described, without limitation. The page shown in diagram 1000 may provide interaction with the gallery, which may be included with the moment component. This interface page may include a title 1010, and optionally a subtitle 1012. The gallery page may additionally include a collection of moments 1020, 1030.

For example, a first moment 1020 may relate to a moment that occurred in Chicago, Ill. The first moment 1020 may include a moment title 1022 with information about the moment, such as location and date, for example. The first moment 1020 may additionally include a share link 1024 to share the moment with another user. A sample of photography products 1026, 1028, and others may be provided with the first moment 1020. Optionally, all photography products from the first moment 1020 may be displayed in the gallery.

In another example, a second moment 1030 may relate to a moment that occurred in Miami, Fla. The second moment 1030 may include a moment title 1032 with information about the moment, such as location and date, for example. The second moment 1030 may additionally include a share link 1034 to share the moment with another user. A sample of photography products 1036, 1038, and others may be provided with the second moment 1030. Optionally, all photography products from the second moment 1030 may be displayed in the gallery.

Additional information may be provided for moments displayed in the gallery, for example contractor name, additional location details, duration of moment, time, and/or transaction details if photography products were purchased. Clicking a moment title may direct the customer to a closed moment page, which may be similar to an open moment, but with the chat feature disabled. Sharing may send an invitation to another user or other person to view the moment. Photography products from shared moments can optionally be purchased by parties other than the customer originating the moment.

Referring now to diagram 1100 of FIG. 11, a diagram view of an illustrative interface page for selecting availability for providing contractor services will be described, without limitation. The page shown in diagram 1100 may provide interaction with the matching component for a contractor. This interface page may include a title 1110. This interface page may additionally include a map area 1120. In one example, map area 1120 may occupy approximately the upper two-thirds of the page, without limitation. The map area 1120 may be zoomed, rotated, moved, pinched, and/or otherwise manipulated. The map area 1120 may default to show the user at the center the map. Contractor icons 1122 may be displayed on the map area 1120, indicating additional contractors in the proximity competing for potential customers. Additionally, N-POL icons 1124 may be provided. A compass icon 1126 may be included to assist with orientation.

An availability selector 1130 may be provided to define whether a contractor desires to be matched. The availability selector 1130 may be toggled between an indication of unavailability 1132 and an indication of availability 1134 via an availability toggle 1136.

A criteria selection area 1140 may be provided to define criteria for which the contractor should be searched. In this example, the criteria selection area 1140 includes category markers 1142, 1143 associated with the desired categories, which may be manipulated by the customer to select a photographer category. In the interest of clarity, three categories 1146, 1147, 1148 are illustrated, corresponding with increasing levels of skill and photography equipment. Manipulation of the category markers 1142, 1143 may change the selected categories and associated rates. A create new moment button 1170 may also be provided to create a locally initiated moment.

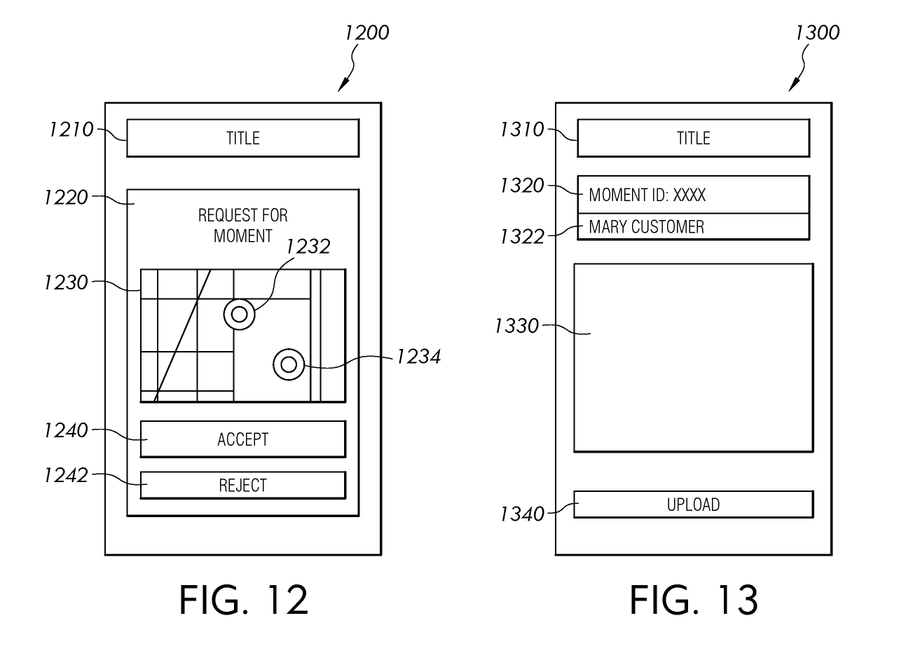

Referring now to diagram 1200 of FIG. 12, a diagram view of an illustrative interface page for reviewing and accepting a photoshoot moment by a contractor will be described, without limitation. The page shown in diagram 1200 may provide interaction with the matching component. This interface page may include a title 1210. The page may additionally include a moment request section 1220. The moment request section may include a map area 1230, which may display the current location of the contractor 1232 and a location of a potential customer to be matched 1234. If the contractor desires to be matched, the contractor may engage the accept button 1240. Otherwise, the contractor may engage the reject button 1242 to deny the request.

Referring now to diagram 1300 of FIG. 13, a diagram view of an illustrative interface page for interacting with the content exchange component by a contractor will be described, without limitation. The page shown in diagram 1300 may provide interaction with the content exchange component. This interface page may include a title 1310. The page may additionally include a moment identification number 1320 and customer name 1322. If the moment is a locally initiated moment, the moment identification number 1320 may be used by the customer to access the moment via the matching component. The customer name 1322 may be omitted for locally initiated moments.

The contractor may be provided a proofing section 1330 to review photography products created during the moment and select which photography products to share with the customer. The customer may share the photography products by engaging an upload button 1340. Uploading the photography products may optionally close the moment.

In operation, a method may be provided to facilitate contracting between parties for photography services. Those of skill in the art will appreciate that the following methods are provided to illustrate an embodiment of the disclosure, and should not be viewed as limiting the disclosure to only those methods or aspects. Skilled artisans will appreciate additional methods within the scope and spirit of the disclosure for performing the operations provided by the examples below after having the benefit of this disclosure. Such additional methods are intended to be included by this disclosure.

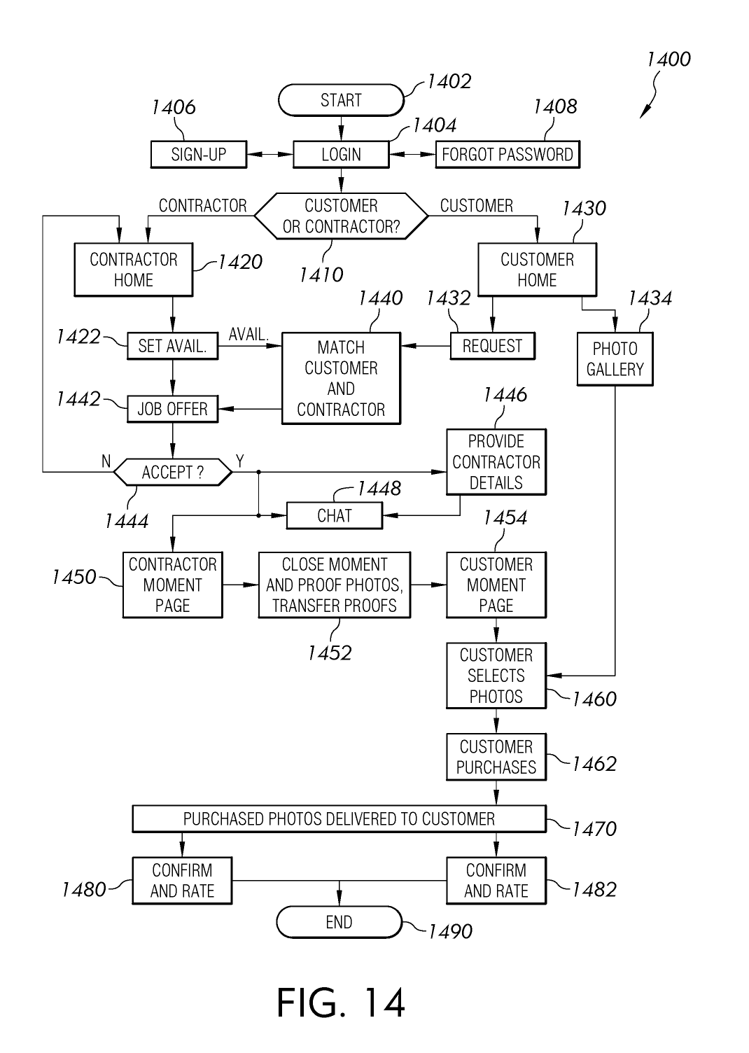

Referring now to flowchart 1400 of FIG. 14, an illustrative method for a high level operation of various components will be described, without limitation. Starting with block 1402, the operation may begin by providing a user with a login page. (Block 1404). If the user does not have a profile, the user may be directed to sign up. (Block 1406). If the user does have a profile, but forgot his or her password, the user may be directed to a password recovery page. (Block 1408).

The operation may next determine whether the user is a customer or a contractor. (Block 1410). If it is determined at block 1410 that the user is a contractor, the operation may continue to the contractor home page. (Block 1420). The contractor may then set his or her availability. (Block 1422).

If it is determined at block 1410 that the user is a customer, the operation may continue to the customer home page. (Block 1430). From the customer home page, the customer may access additional pages of the interface. For example, the customer may access a photo gallery of past moments. (Block 1434). Additionally, from the customer home page of block 1430, the customer may request a new moment. (Block 1432). Additionally, a customer may be able to access a locally initiated moment from the customer home page.

If the customer requests a new moment at block 1432 and a contractor meeting selected criteria is set to available at block 1422, the operation may attempt to match the customer and contractor. (Block 1440). The contractor may then be sent a job offer for the matched moment. (Block 1442). The contractor may decide whether to accept the job offer at block 1444. If it is determined at block 1444 that the contractor does not wish to accept the job offer, the operation may continue to the contractor home at block 1420. If it is determined at block 1444 that the contractor wishes to accept the job offer, the contractor may be directed to a contractor moment page 1450. Additionally, if it is determined at block 1444 that the contractor wishes to accept the job offer, the customer may be provided with the contractor details. (Block 1446). The customer and contractor may chat. (Block 1448).

After the moment has completed, the moment may be closed and the photography products from the moment may be proofed by the contractor. (Block 1452). The photography products may be shared by the contractor with the customer at block 1452. The customer view the shared photography products using the customer moment page. (Block 1454).

From the customer moment page of block 1454, from the photo gallery of block 1434, or from a locally initiated moment, the customer may select photography products for purchase. (Block 1460). The customer may then purchase the selected photography products. (Block 1462). The purchased photography products may be delivered to the customer. (Block 1470). The contractor may then confirm conclusion of the contracting service and rate the customer. (Block 1480). Similarly, the customer may confirm conclusion of the contracting service and rate the contractor. (Block 1482). The operation may then terminate at block 1490.

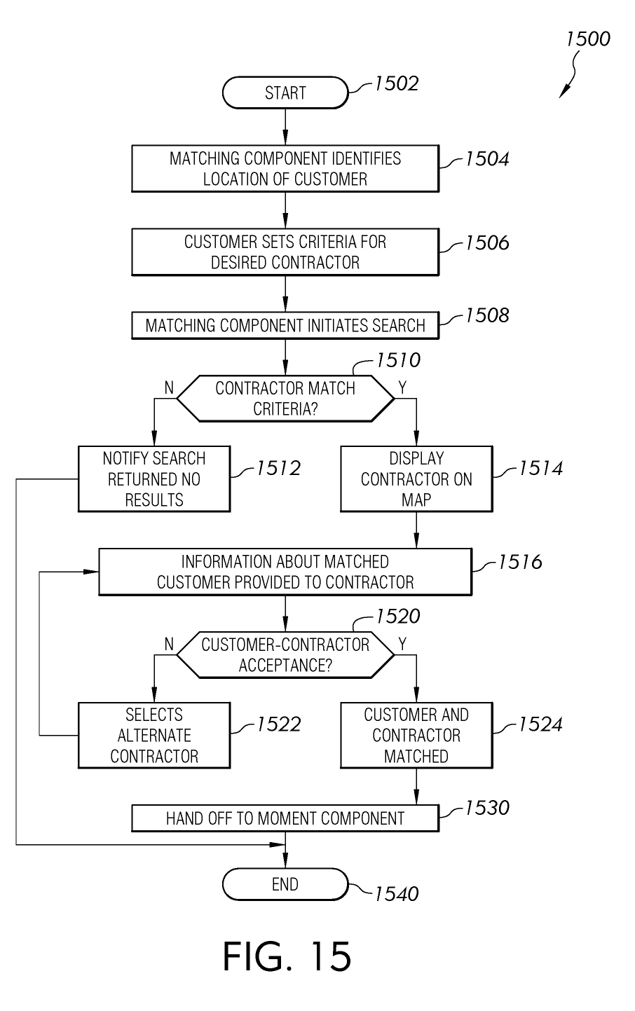

Referring now to flowchart 1500 of FIG. 15, an illustrative method for an operation of the matching component will be described, without limitation. Starting with block 1502, the operation may begin by the matching component identifying the location of a customer. (Block 1504). The customer may then set criteria for a desired contractor. (Block 1506). The matching component may then initiate a search. (Block 1508).

It may then be determined if a contractor matching the criteria is located. (Block 1510). If it is determined at block 1510 that no contractor matching the criteria can be located, a message may be communicated to the customer indicating no matches. (Block 1512.) The operation may then terminate at block 1540. If it is determined at block 1510 that a contractor is located matching the criteria, the contractor may be displayed on a map to the customer. (Block 1514). Information about the customer may be provided to the contractor. (Block 1516).

It may then be determined whether the contractor accepts the moment with the customer. (Block 1520). If it is determined at block 1520 that the contractor does not accept the customer, the operation may select an alternative contractor. (Block 1522). The operation may then continue to provide information about the customer to the next located contractor at block 1516. If it is determined at block 1520 that the contractor accepts the customer, the contractor and customer may be matched for the moment. (Block 1524). The operation may then be handed off to the moment component. (Block 1530). This aspect of the operation may then terminate at block 1540. The matching component may alternatively associate a contractor and a customer matched view a locally initiated moment, which may also be handed off to the moment component.

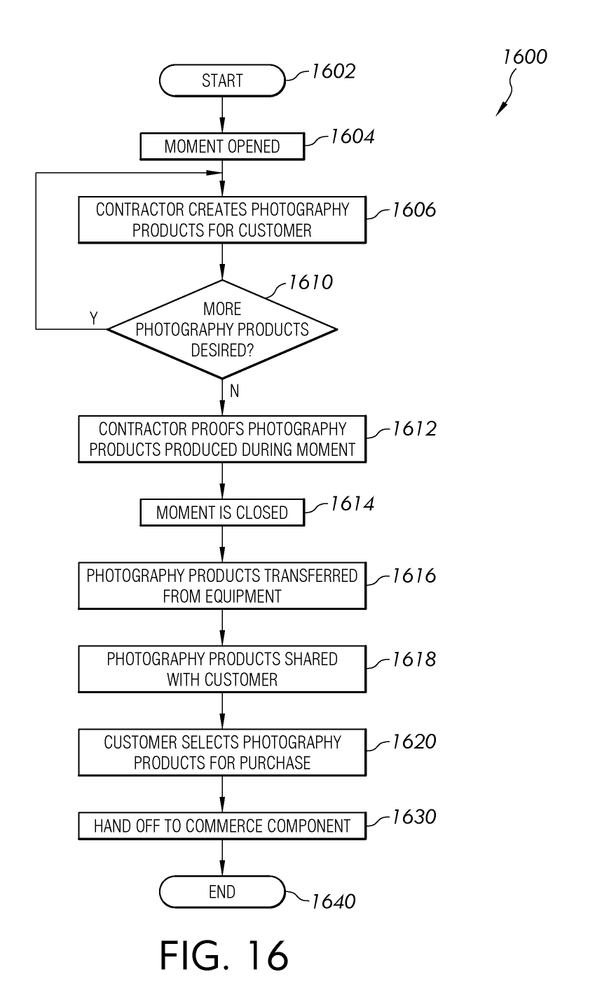

Referring now to flowchart 1600 of FIG. 16, an illustrative method for an operation of the moment component will be described, without limitation. Starting with block 1602, the operation may begin by opening the moment. (Block 1604). The contractor may then create photography products for the customer. (Block 1606). It may then be determined whether more photography products should be created for the moment. (Block 1610).

If it is determined at block 1610 that more photography products should be created, the operation may return to block 1606 and continue the moment. If it is determined at block 1610 that more photography products should not be created, the contractor may proof the photography products produced during the moment. (Block 1612). The moment may then be closed. (Block 1614). The photography products may be transferred from the photography equipment. (Block 1616). The photography products may then be shared with the customer. (Block 1618). The customer may select photography products for purchase. (Block 1620). The operation may then handoff to the commerce component. (Block 1630). This aspect of the operation may then terminate at block 1640.

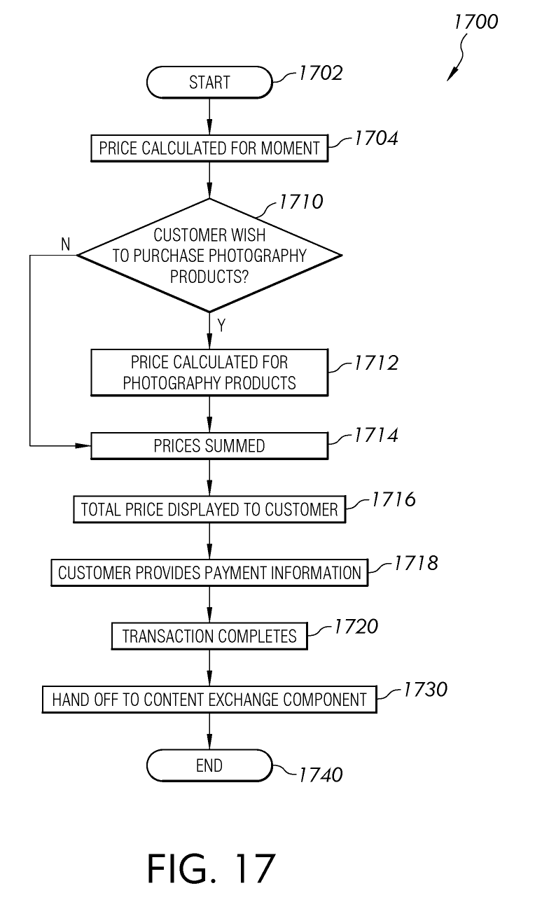

Referring now to flowchart 1700 of FIG. 17, an illustrative method for an operation of the commerce component will be described, without limitation. Starting with block 1702, the operation may begin by calculating a price for the moment. (Block 1704).

It may then be determined whether the customer wishes to purchase photography products. (Block 1710). If it is determined at block 1710 that the customer wishes to purchase photography products, the price may be calculated for the selected photography products. (Block 1712). The prices may then be summed. (Block 1714). If it is determined that the customer does not wish to purchase photography products at block 1710, the applicable prices may also be summed. (Block 1714).

The total price may then be displayed to the customer. (Block 1716). The customer may provide payment information. (Block 1718). The transaction may then be completed. (Block 1720). The operation may then be handed off to the content exchange component. (Block 1730). This aspect of the operation may then terminate at block 1740.

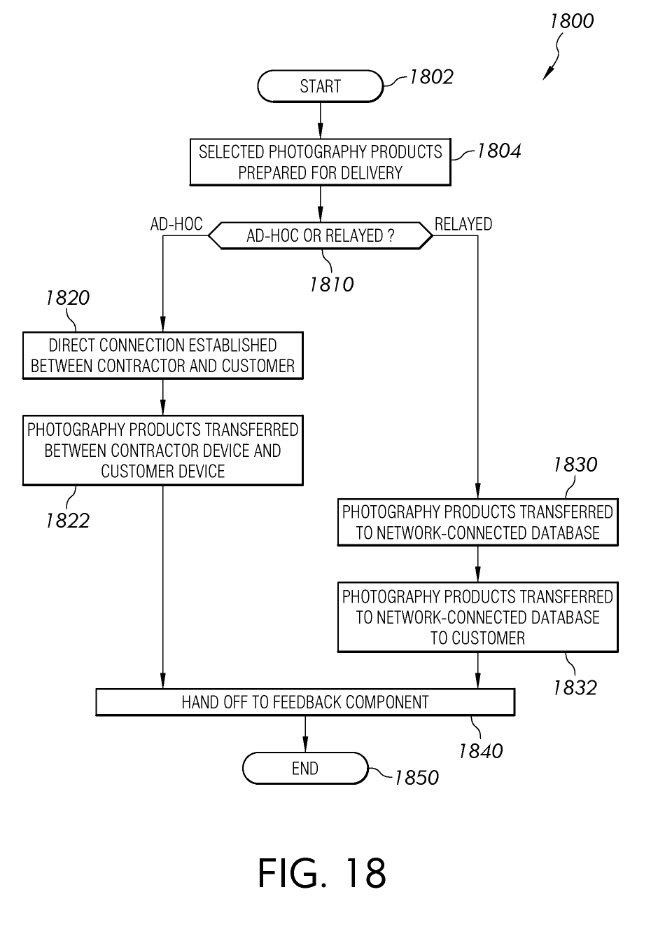

Referring now to flowchart 1800 of FIG. 18, an illustrative method for an operation of the content exchange component will be described, without limitation. Starting with block 1802, the operation may begin by preparing selected photography products for delivery. (Block 1804).

It may then be determined whether the photography products will be delivered using an ad-hoc communication or relayed communication. (Block 1810). If it is determined at block 1810 that the photography products will be communicated ad-hoc, a direct connection may be established between the contractor and the customer. (Block 1820). The photography products may then be transferred between the contractor device and customer device. (Block 1822).

If it is determined at block 1810 that the photography products will be communicated using a relayed connection, the photography products may be transferred from the contractor to a network-connected database. (Block 1830). The photography products may then be transferred from the network-connected database to the customer. (Block 1832). The operation may then be handed off to the feedback component. (Block 1840). This aspect of the operation may then terminate at block 1850.

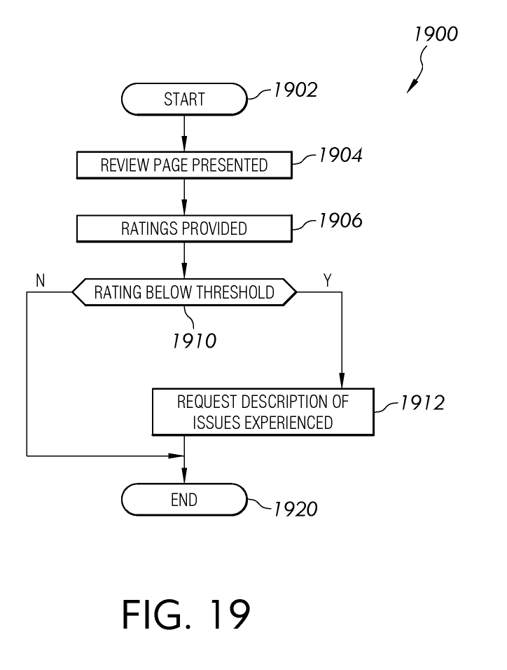

Referring now to flowchart 1900 of FIG. 19, an illustrative method for an operation of the feedback component will be described, without limitation. Starting with block 1902, the operation may begin by presenting a review page. (Block 1904). The ratings may be provided by the reviewing user. (Block 1906). It may then be determined if the provided ratings are below a threshold of acceptability. (Block 1910). If it is determined at block 1910 that the ratings are not below the threshold of acceptability, the operation may then terminate at block 1920. If it is determined at block 1910 that the ratings are below the threshold of acceptability, a description of issues experienced may be requested. (Block 1912). The operation may then terminate at block 1920.

While various aspects have been described in the above disclosure, the description of this disclosure is intended to illustrate and not limit the scope of the invention. The invention is defined by the scope of the appended claims and not the illustrations and examples provided in the above disclosure. Skilled artisans will appreciate additional aspects of the invention, which may be realized in alternative embodiments, after having the benefit of the above disclosure. Other aspects, advantages, embodiments, and modifications are within the scope of the following claims.

What is claimed is:

1. A photography product contractor matching system comprising:
a matching component to connect a customer and a contractor;
a moment component to control a moment between the customer and the contractor, photography products created during the moment being viewable via an interface;
a commerce component to collect a fee relating to occurrence of the moment and purchasing at least some of the photography products created during the moment;
a content exchange component to facilitate delivering the photography products;
wherein the matching component, the moment component, the commerce component, and the content exchange component are manipulable via the interface;
wherein the photography products associated with the moment are communicable between photography equipment operated by the contractor and the content exchange component;
wherein the customer is associable with a customer profile storable in a database accessible via a network;
wherein the contractor is associable with a contractor profile storable in the database; and
wherein at least some of the photography products are storable in the database and accessible from the database.

2. The photography product contractor matching system of claim 1, wherein the matching component comprises:
a search module to define criteria for the contractor to be identified and to identify the contractor in compliance with the criteria;
a mapping module to provide a visualization of the contractor that is identified via the search module using the interface; and
wherein the contractor profile comprises fields analyzable to determine the compliance with the criteria.

3. The photography product contractor matching system of claim 2, further comprising:
a feedback component to receive feedback relating to the contractor, the customer, the moment, and the photography products; and
wherein at least part of the feedback is includable in the criteria.

4. The photography product contractor matching system of claim 2, wherein the criteria comprise proximity of the contractor to a location of the customer and a category of the contractor.

5. The photography product contractor matching system of claim 2, wherein information regarding a nearby photo opportunity location is storable in the database and accessible to indicate the nearby photo opportunity location and promote occupancy by the customer and the contractor in the nearby photo opportunity location.

6. The photography product contractor matching system of claim 1, wherein the moment component comprises:
an active moment module to open the moment between the customer and the contractor, manage the moment that is opened, and close the moment that has concluded; and
wherein at least part of the photography products created during the moment are deliverable to the customer via the content exchange component.

7. The photography product contractor matching system of claim 1, wherein the fee comprises:
a first fee relating to the moment managed by the moment component;
a second fee relating to purchase of at least some of the photography products created during the moment and deliverable via the content exchange component; and
wherein a first portion of the first fee and a second portion of the second fee are includable in a commission.

8. The photography product contractor matching system of claim 1, further comprising:
a frontend on which the interface is interactively viewable; and
wherein the content exchange component comprises a local exchange module to deliver at least some of the photography products via an ad-hoc network communication between the frontend associated with the contractor and the frontend associated with the customer.

9. The photography product contractor matching system of claim 1, further comprising:
a frontend on which the interface is interactively viewable; and
wherein the content exchange component comprises a relayed exchange module to deliver at least some of the photography products via a first relayed communication between the frontend associated with the contractor and the database and a second relayed communication between the database and the frontend associated with the customer.

10. The photography product contractor matching system of claim 1, wherein the moment is capable of being opened prior to creating the customer profile to be associated with the customer.

11. The photography product contractor matching system of claim 1, wherein the photography products created during the moment are deliverable after the moment is closed.

12. A photography product contractor matching system comprising:
a matching component to connect a customer and a contractor, the matching component further comprising:
a search module to define criteria for the contractor to be identified and to identify the contractor in compliance with the criteria, and
a mapping module to provide a visualization of the contractor that is identified via the search module using an interface;
a moment component to control a moment between the customer and the contractor, photography products created during the moment being viewable via the interface, the moment component further comprising:
an active moment module to open the moment between the customer and the contractor, manage the moment that is opened, and close the moment that has concluded;
a content exchange component to facilitate delivering the photography products;
a frontend on which the interface is interactively viewable;
wherein the matching component, the moment component, and the content exchange component are manipulable via the frontend;
wherein the photography products associated with the moment are communicable between photography equipment operated by the contractor and the content exchange component;
wherein the criteria comprise proximity of the contractor to a location of the customer and a category of the contractor;
wherein at least part of the photography products created during the moment are deliverable to the customer via the content exchange component;
wherein the customer is associable with a customer profile storable in a database accessible via a network;
wherein the contractor is associable with a contractor profile storable in the database;
wherein the contractor profile comprises fields analyzable to determine the compliance with the criteria;
wherein at least some of the photography products are storable in the database and accessible from the database;
wherein the moment is capable of being opened prior to creating the customer profile to be associated with the customer; and
wherein the photography products created during the moment are deliverable after the moment is closed.

13. The photography product contractor matching system of claim 12, further comprising:
a commerce component to collect a fee relating to occurrence of the moment and purchasing at least some of the photography products created during the moment; and
wherein the fee comprises:
a first fee relating to the moment managed by the moment component, and
a second fee relating to purchase of at least some of the photography products created during the moment and deliverable via the content exchange component.

14. The photography product contractor matching system of claim 12, wherein the content exchange component comprises a local exchange module to deliver at least some of the photography products via an ad-hoc network communication between the frontend associated with the contractor and the frontend associated with the customer.

15. The photography product contractor matching system of claim 12, wherein the content exchange component comprises a relayed exchange module to deliver at least some of the photography products via a first relayed communication between the frontend associated with the contractor and the database and a second relayed communication between the database and the frontend associated with the customer.

16. A method for matching a photography contractor and a customer using a photography product matching system, the method comprising:
(a) connecting the customer and a contractor using a matching component;
(b) controlling a moment between the customer and the contractor using a moment component, photography products created during the moment being viewable via an interface;
(c) collecting a fee using a commerce component relating to occurrence of the moment and purchase of at least some of the photography products created during the moment;
(d) delivering the photography products using a content exchange component;
(e) providing the interface to be interactively viewed using a frontend;
wherein the matching component, the moment component, the commerce component, and the content exchange component are manipulable via the interface;
wherein the photography products associated with the moment are communicable between photography equipment operated by the contractor and the content exchange component;
wherein the customer is associable with a customer profile storable in a database accessible via a network;
wherein the contractor is associable with a contractor profile storable in the database;
wherein at least some of the photography products are storable in the database and accessible from the database; and
wherein the moment is capable of being opened prior to creating the customer profile to be associated with the customer.

17. The method of claim 16:
wherein step (a) further comprises:
(i) defining criteria for the contractor to be identified using a search module,
(ii) identifying the contractor in compliance with the criteria using the search module, and
(iii) providing a visualization of the contractor that is identified using a mapping module;
wherein the contractor profile comprises fields analyzable to determine the compliance with the criteria;
wherein the criteria comprise proximity of the contractor to a location of the customer and a category of the contractor;
wherein step (b) further comprises:
(iv) opening the moment between the customer and the contractor using an active moment module,
(v) managing the moment that is opened using the active moment module, and
(vi) closing the moment that has concluded using the active moment module; and
wherein at least part of the photography products created during the moment are deliverable to the customer via the content exchange component.

18. The method of claim 16, wherein the fee comprises:
a first fee relating to the moment managed by the moment component;
a second fee relating to purchase of at least some of the photography products created during the moment and deliverable via the content exchange component; and
wherein a first portion of the first fee and a second portion of the second fee are includable in a commission.

19. The method of claim 16, wherein step (d) further comprises:
(vii) delivering at least some of the photography products using a local exchange module via an ad-hoc network communication between the frontend associated with the contractor and the frontend associated with the customer; and
wherein the photography products created during the moment are deliverable after the moment is closed.

20. The method of claim 16, wherein step (d) further comprises:
(viii) delivering at least some of the photography products using a relayed exchange module via a first relayed communication between the frontend associated with the contractor and the database, and
(ix) delivering at least some of the photography products using the relayed exchange module via a second relayed communication between the database and the frontend associated with the customer; and
wherein the photography products created during the moment are deliverable after the moment is closed.
